(19) United States
(12) Patent Application Publication
(10) Pub. No.: US 2025/0253874 A1
(43) Pub. Date: Aug. 7, 2025

(54) DEVICE CALCULATING DOPPLER SHIFT AND OSCILLATOR FREQUENCY OFFSET AND OPERATING METHOD THEREOF

(71) Applicant: SAMSUNG ELECTRONICS CO., LTD., SUWON-SI, GYEONGGI-DO (KR)

(72) Inventors: Seungwoo Park, Suwon-si (KR); Kiil Kim, Suwon-si (KR); Beomkon Kim, Suwon-si (KR); Joohyun Do, Suwon-si (KR)

(21) Appl. No.: 18/607,658

(22) Filed: Mar. 18, 2024

(30) Foreign Application Priority Data
Mar. 21, 2023 (KR) 10-2023-0036888
Jul. 20, 2023 (KR) 10-2023-0094658

(51) Int. Cl. H04B 1/00; H04B 1/401; H04L 5/00; H04L 25/02

(52) U.S. Cl. CPC H04B 1/0096; H04B 1/401; H04L 5/0048; H04L 25/0204

(57) ABSTRACT

A receiving device includes a transceiver configured to receive, from a transmitting device, a first reference signal included in a band in which a center frequency is a first frequency, receive, from the transmitting device, a second reference signal included in a band in which a center frequency is a second frequency different from the first frequency, and down-convert each of the first and second reference signals, and a communication processor configured to perform channel estimation based on each of the down-converted first reference signal and the down-converted second reference signal to obtain a plurality of channel estimate values, calculate a Doppler shift frequency and an oscillator frequency offset, based on the plurality of channel estimate values, and perform a compensation operation to compensate for the Doppler shift frequency and reduce or eliminate the oscillator frequency offset.

### CROSS-REFERENCE TO RELATED APPLICATIONS

This application is based on and claims priority under 35 USC § 119 to Korean Patent Application Nos. 10-2023-0036888, filed on Mar. 21, 2023, and 10-2023-0094658 on Jul. 20, 2023, in the Korean Intellectual Property Office, the disclosures of which are incorporated by reference herein in their entireties.

### TECHNICAL FIELD

This disclosure relates generally to wireless communications and more particularly to a receiving device that calculates and compensates for Doppler shift and an oscillator frequency offset.

### DISCUSSION OF RELATED ART

Wireless communication devices may transmit/receive signals based on clock signals generated through oscillators. Oscillators included in each of a transmitting device and a receiving device may generate clock signals having the same frequency. In this case, frequency drift may occur in the oscillators of each device over time or as environmental conditions (e.g., temperature) change. Frequency drift may cause an oscillator frequency offset between the transmitting device oscillator and the receiving device oscillator.

In addition, if the transmitting or receiving device is a device used while in motion, such as a smartphone, the Doppler effect may occur due to such motion. The Doppler effect may cause a Doppler shift frequency (the change in frequency due to the Doppler shift) depending on a relative speed between the transmitting and receiving devices (where the relative speed is the combined speed of the first and second devices moving towards each other or away from each other).

Frequency errors, such as the oscillator frequency offset and the Doppler shift frequency, may degrade communication performance between the transmitting and receiving devices. Therefore, it is desirable to accurately calculate the oscillator frequency offset and the Doppler shift frequency and compensate for the same.

### SUMMARY

Embodiments of the inventive concept provide a receiving device capable of accurately calculating, and compensating for, an oscillator frequency offset and a Doppler shift frequency.

According to an aspect of the inventive concept, there is provided a receiving device including a transceiver configured to receive, from a transmitting device, a first reference signal included in a band in which a center frequency is a first frequency, receive, from the transmitting device, a second reference signal included in a band in which a center frequency is a second frequency different from the first frequency, and down-convert each of the first reference signal and the second reference signal; and a communication processor performing channel estimation based on each of the down-converted first reference signal and the down-converted second reference signal to obtain a plurality of channel estimate values, calculating a Doppler shift frequency and an oscillator frequency offset based on the plurality of channel estimate values, and performing a compensation operation to compensate for the Doppler shift frequency and reduce or eliminate the oscillator frequency offset.

According to another aspect of the inventive concept, there is provided an operating method of a receiving device including a transceiver and a communications processor, including receiving, by the transceiver from a transmitting device a first reference signal included in a band in which a center frequency is a first frequency, receiving by the transceiver a second reference signal included in a band in which a center frequency is a second frequency different from the first frequency, down-converting each of the first reference signal and the second reference signal through the transceiver, performing channel estimation based on each of the down-converted first reference signal and the down-converted second reference signal through the communication processor to obtain a plurality of channel estimate values, calculating a Doppler shift frequency and an oscillator frequency offset based on the plurality of channel estimate values through the communication processor, and performing a compensation operation to compensate for the Doppler shift frequency and reduce or eliminate the oscillator frequency offset through the communication processor.

According to another aspect of the inventive concept, there is provided a receiving device including a transceiver receiving from a transmitting device a first reference signal included in a band in which a center frequency is a first frequency, receiving from the transmitting device a second reference signal included in a band in which a center frequency is a second frequency different from the first frequency, receiving a global navigation satellite system (GNSS) signal from a satellite, and down-converting each of the first reference signal and the second reference signal; a communication processor performing channel estimation based on the down-converted first reference signal to obtain first and second channel estimate values and performing channel estimation based on the down-converted second reference signal to obtain third and fourth channel estimate values, and a GNSS circuit obtaining an oscillator frequency offset based on the GNSS signal, wherein the communication processor calculates the Doppler shift frequency and the oscillator frequency offset based on the first to fourth channel estimate values or calculates the Doppler shift frequency based on the oscillator frequency offset obtained through the GNSS circuit and the first and second channel estimate values, and performs a compensation operation to compensate for the Doppler shift frequency and reduce or eliminate the oscillator frequency offset.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a communication system according to an embodiment;

FIG. 2 is a block diagram illustrating a receiving device according to an embodiment;

FIG. 3 is a graph illustrating frequency bands of a first reference signal and a second reference signal received through a transceiver, according to an embodiment;

FIG. 4 is a circuit diagram illustrating a detailed structure of an antenna, a transceiver and an oscillator of a receiving device according to an embodiment;

FIG. 5 is a diagram illustrating a resource block used by a receiving device according to an embodiment;

FIG. 6 is a circuit diagram illustrating a detailed structure of a compensation circuit of a receiving device according to an embodiment;

FIG. 7 is a flowchart illustrating an operating method of a receiving device, according to an embodiment;

FIG. 8 is a flowchart illustrating a method by which a receiving device calculates a Doppler shift frequency and an oscillator frequency offset, according to an embodiment;

FIG. 9 is a flowchart illustrating a method by which a receiving device calculates an oscillator frequency offset and a Doppler shift by using a global navigation satellite systems (GNSS) circuit, according to an embodiment;

FIG. 10 is a flowchart illustrating a method by which a receiving device performs a compensation operation, based on a calculated oscillator frequency offset and Doppler shift, according to an embodiment; and

FIG. 11 is a block diagram illustrating a wireless communication device according to an embodiment.

### DETAILED DESCRIPTION OF EMBODIMENTS

Hereinafter, embodiments are described in detail with reference to the accompanying drawings.

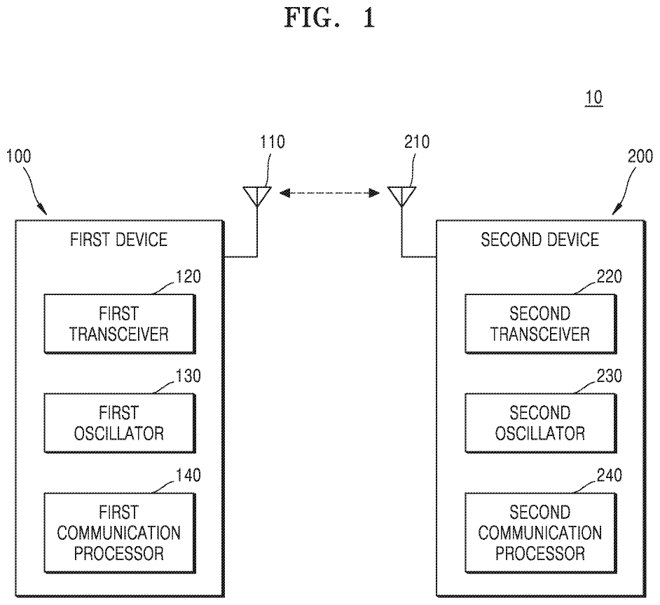

FIG. 1 is a block diagram illustrating a communication system 10 according to an embodiment.

Referring to FIG. 1, the communication system 10 according to an embodiment may include a first device 100 and a second device 200.

The first device 100 may communicate with the second device 200. For example, the first device 100 may transmit a signal to a second device 200, and in this case, the first device 100 may be referred to as a transmitting device and the second device 200 may be referred to as a receiving device. Conversely, when the second device 200 transmits a signal to the first device 100, the second device 200 may be referred to as a transmitting device and the first device 100 may be referred to as a receiving device.

In an embodiment, the first device 100 may be a base station and the second device 200 may be a user device.

The base station may be a fixed station that communicates with a user device and other base stations or a wired network, and may exchange data and control information by communicating with the user device and other base stations. A base station can also have mobile capability. Base stations may also be referred to as Node B, evolved-Node B (eNB), base transceiver system (BTS), and access point (AP).

The user device is an electronic device capable of wireless communication, may be fixed or mobile, and may be any one of a variety of devices capable of transmitting and receiving data and control information by communicating with a base station. User devices may also be referred to as terminal equipment, mobile station (MS), mobile terminal (MT), user terminal (UT), subscriber station (SS), wireless device, handheld device, etc.

However, the inventive concept is not limited thereto, and the first device 100 may be a user device and the second device 200 may be a base station, or both the first device 100 and the second device 200 may be user devices.

The first device 100 may include a first antenna 110, a first transceiver 120, a first oscillator 130, and a first communication processor 140.

The first transceiver 120 may transmit a signal to the second device 200 through the first antenna 110 or receive a signal transmitted from the second device 200 through the first antenna 110. The first transceiver 120 may up-convert a frequency of a signal generated by the first communication processor 140 and transmit the signal to the second device 200 through the first antenna 110. The first transceiver 120 may down-convert a frequency of a signal received from the second device 200 through the first antenna 110 and provide the down-converted signal to the first communication processor 140.

The first transceiver 120 may up-convert or down-convert a frequency of a signal based on a clock signal received from the first oscillator 130. (Herein, a clock signal may be a square wave, a pulse train or a sinusoidal signal.) The first oscillator 130 may generate a clock signal having a preset oscillator frequency (e.g., 2 GHZ).

The first communication processor 140 may control an overall communication operation of the first device 100. The first communication processor 140 may generate a signal to be transmitted from the first device 100 to the second device 200 through the first transceiver 120.

The first communication processor 140 may be implemented through a processor, a numeric processing unit (NPU), and/or a graphic processing unit (GPU).

The second device 200 may include a second antenna 210, a second transceiver 220, a second oscillator 230, and a second communication processor 240. The operation of the second antenna 210, the second transceiver 220, the second oscillator 230, and the second communication processor 240 included in the second device 200 may be the same as the operation of the first antenna 110, the first transceiver 120, the first oscillator 130, and the first communication processor 140.

The first oscillator 130 and the second oscillator 230 may generate clock signals having the same oscillator frequency. Accordingly, the first device 100 and the second device 200 may process transmitted and received signals based on a clock signal of the same oscillator frequency. Here, if the external environment such as temperature, humidity, etc. changes, or properties of the first/second device electronics change over time, a frequency drift phenomenon may occur in the first oscillator 130 and/or the second oscillator 230. Accordingly, an offset may occur between the oscillator frequency generated by the first oscillator 130 and the oscillator frequency generated by the second oscillator 230. This offset may be referred to as an oscillator frequency offset.

In addition, when the first device 100 or the second device 200 is in motion, the Doppler effect may occur between the first device 100 and the second device 200 due to the relative motion between the first and second devices. Accordingly, a signal received by the second device 200 may include a Doppler shift, hereafter, a “Doppler shift frequency” (the frequency by which the received signal is shifted due to the Doppler effect).

Frequency errors, such as the oscillator frequency offset and the Doppler shift frequency degrade communication performance between the transmitting device and the receiving device, so accurate calculation is desirable.

In an embodiment, when a signal is received through the first transceiver 120, the first communication processor 140 may calculate a Doppler shift frequency and an oscillator frequency offset based on a first reference signal and a second reference signal. In addition, when a signal is received through the second transceiver 220, the second communication processor 240 may calculate a Doppler shift frequency and an oscillator frequency offset based on the first reference signal and the second reference signal. Accordingly, degradation in communication performance between the first device 100 and the second device 200 may be prevented.

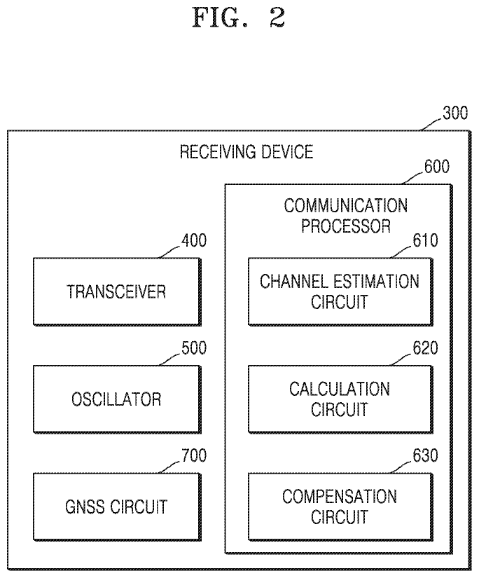

A more detailed method of calculating the Doppler shift frequency and the oscillator frequency offset is described with reference to FIG. 2 and the following drawings.

FIG. 2 is a block diagram illustrating a receiving device 300 according to an embodiment.

Referring to FIG. 2, the receiving device 300 according to an embodiment may include a transceiver 400, an oscillator 500, and a communication processor 600.

The receiving device 300 may be an example of either the first device 100 or the second device 200 in the embodiment of FIG. 1. For example, when a signal is transmitted from the first device 100 to the second device 200, the first device 100 may be a transmitting device and the second device 200 may be a receiving device 300. Conversely, when a signal is transmitted from the second device 200 to the first device 100, the second device 200 may be a transmitting device and the first device 100 may be a receiving device 300.

The transceiver 400 may receive a first reference signal included in a band having a first frequency as the center frequency from the transmitting device. In addition, the transceiver 400 may receive a second reference signal included in a band having a second frequency as the center frequency from the transmitting device. Here, the first and second frequencies may be different.

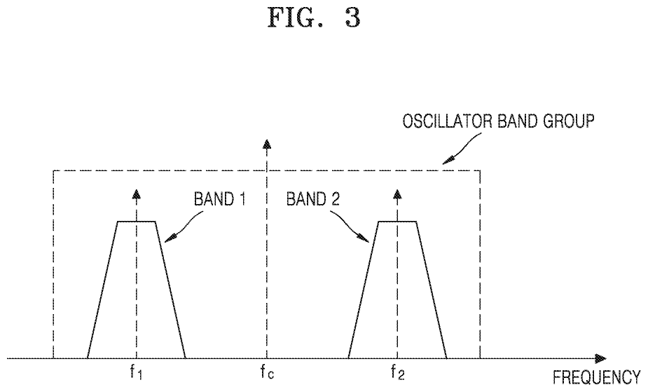

Here, examples of the frequency bands including the first reference signal and the second reference signal are described below with reference to FIG. 3.

FIG. 3 is a graph illustrating frequency bands of the first reference signal and the second reference signal received through a transceiver according to an embodiment.

Referring to FIG. 3, a graph illustrating an oscillator band group and frequency bands of the first and second reference signals included in the oscillator band group may be identified.

The oscillator band group may include a plurality of frequency bands that may collectively carry information signals with a carrier aggregation (CA) scheme. Here, each of the plurality of frequency bands included in the oscillator band group may correspond to a component carrier (CC). The oscillator band group may have an oscillator frequency f_{c} as the center frequency.

The oscillator band group may include a first band (“band 1”) and a second band (“band 2”). The first band may be a band in which the center frequency is the first frequency f₁, and the first reference signal may be a signal included in the first band. The first reference signal may be transmitted by a component carrier having the first frequency f₁. The second band may be a band in which the center frequency is the second frequency f₂, and the second reference signal may be a signal included in the second band. The second reference signal may be transmitted by a component carrier having the second frequency f₂.

Returning to FIG. 2, in a receive path, the transceiver 400 may down-convert each of the first and second reference signals. The first reference signal and the second reference signal may be generated by a transmitting device to be included in an oscillator band group in which the center frequency is the oscillator frequency and may be up-converted by the transmitting device and transmitted to the receiving device 300. The transceiver 400 may down-convert the received first and second reference signals to be included in an oscillator band group in which the center frequency is the oscillator frequency. Here, the transceiver 400 may down-convert the first and second reference signals based on a clock signal generated by the oscillator 500.

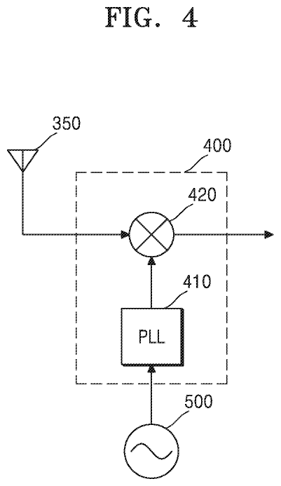

A more detailed circuit structure of the transceiver 400 and oscillator 500 according to an example is described with reference to FIG. 4.

FIG. 4 is a circuit diagram illustrating a detailed structure of receive path circuitry including an antenna 350, the transceiver 400, and the oscillator 500 of the receiving device 300 according to an embodiment.

The transceiver 400 may receive the first reference signal and the second reference signal through the antenna 350.

The transceiver 400 may include a phase locked loop (PLL) 410 and a mixer 420.

The PLL 410 may receive a clock signal from the oscillator 500. The oscillator 500 may generate a clock signal having an oscillator frequency. The oscillator 500 may output the generated clock signal to the PLL 410.

The PLL 410 may be a circuit for maintaining the frequency of the clock signal generated by the oscillator 500 constant. Here, the PLL 410 may adjust the frequency of the clock signal generated by the oscillator 500 so that the clock signal generated by the oscillator 500 has a target frequency. Thus, when the clock signal generated by the oscillator 500 passes through the PLL 410, the clock signal as output by the PLL 410, hereafter, the “PLL clock signal”, may have a constant oscillator frequency.

The mixer 420 may receive the first and second reference signals and the PLL clock signal. The mixer 420 may down-convert each of the received first and second reference signals by the frequency of the PLL clock signal.

Referring back to FIG. 2, the transceiver 400 may output the down-converted first reference signal and the down-converted second reference signal to the communication processor 600.

The communication processor 600 may include a channel estimation circuit 610, a calculation circuit 620, and a compensation circuit 630.

The channel estimation circuit 610 may obtain a plurality of channel estimate values by performing channel estimation based on each of the down-converted first reference signal and the down-converted second reference signal.

In an embodiment, the channel estimation circuit 610 may obtain a first channel estimate value and a second channel estimate value based on the first reference signal and obtain a third channel estimate value and a fourth channel estimate value based on the second reference signal.

In detail, the channel estimation circuit 610 may obtain the first channel estimate value by performing channel estimation based on a first symbol of the first reference signal. The channel estimation circuit 610 may obtain a second channel estimate value by performing channel estimation based on a second symbol of the first reference signal. In addition, the channel estimation circuit 610 may obtain a third channel estimate value by performing channel estimation based on a third symbol of the second reference signal. The channel estimation circuit 610 may obtain a fourth channel estimate value by performing channel estimation based on a fourth symbol of the second reference signal.

Here, the first symbol of the first reference signal and the second symbol of the first reference signal may have a preset reference symbol interval on a time axis. In addition, the third symbol of the second reference signal and the fourth symbol of the second reference signal may have a reference symbol interval (e.g., the same as the preset reference symbol interval) on the time axis. For example, the first symbol of the first reference signal and the second symbol of the first reference signal may have the same symbol interval as that of the third symbol of the second reference signal and the fourth symbol of the second reference signal.

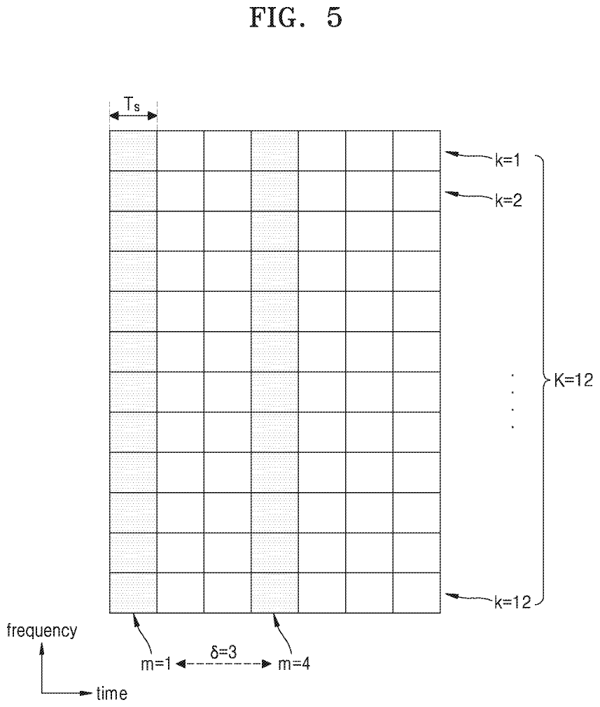

Here, exemplary details of the symbol interval and channel estimate value are described with reference to FIG. 5.

FIG. 5 is a diagram illustrating a resource block used by a receiving device according to an embodiment. A horizontal axis of the resource block may be a time axis, and a vertical axis of the resource block may be a frequency axis. The frequency axis may include a total (K) of 12 subcarriers “k” (k=1 to k=12), and the time axis may include 7 symbols “m” (m=1 to m=7). Here, a symbol duration of one symbol may be Tₛ.

In an example of a resource block corresponding to the first reference signal, the first symbol of the first reference signal may be a symbol denoted as m=1, and the second symbol of the first reference signal may be a symbol denoted as m=4. Here, a reference symbol interval 8 may be 3 (=4−1).

Here, the first channel estimate value may include values obtained by performing channel estimation on each of a plurality of subcarriers representing the first symbol of the first reference signal. (The state or change in state of a subcarrier may represent a symbol.) Thus, the first channel estimate value may include a value obtained by performing channel estimation on a first subcarrier (k=1) of the first symbol of the first reference signal to a value obtained by performing channel estimation on a twelfth subcarrier (k=12) of the first symbol of the first reference signal.

Similarly, the second channel estimate value may include values obtained by performing channel estimation on each of a plurality of subcarriers representing the second symbol of the first reference signal.

For the second reference signal, the reference symbol interval 8 may also be 3. Further, as discussed earlier, the second reference signal may be represented by subcarriers in a different frequency band (Band 2 of FIG. 3) than that of the first reference signal (Band 1). When the first symbol of the first reference signal and the second symbol of the first reference signal have the same symbol interval as that of the third symbol of the second reference signal and the fourth symbol of the second reference signal, if the third symbol of the second reference signal is a symbol with m=1, the fourth symbol of the second reference signal may be a symbol with m=4.

Referring back to FIG. 2, the channel estimation circuit 610 may provide a plurality of obtained channel estimate values to the calculation circuit 620.

The calculation circuit 620 may calculate a Doppler shift frequency and an oscillator frequency offset based on the channel estimate values.

To this end, the calculation circuit 620 may calculate a relative velocity between the transmitting device and the receiving device 300 based on the channel estimate values and calculate the Doppler shift frequency and the oscillator frequency offset based on the relative speed. If a first device of the transmitting or receiving device is at a fixed location and the second device is in motion, relative speed may be the speed of the second device moving away from or towards the first device. If both devices are in motion, relative speed may be understood as the combined speed at which the first and second devices are moving toward each other or away from each other.

To calculate the relative speed, the calculation circuit 620 may first calculate a first correlation value, which is a correlation value between the first channel estimate value and the second channel estimate value. Here, the calculation circuit 620 may calculate the first correlation value using Equation 1 below.

$${\sum }_{k = 1}^{K} {H}_{( {m}_{1} + δ ) , 1} [ k ] {H}_{{m}_{1} , 1}^{*} [ k ] = {Ae}^{j ( 2 πδ {T}_{s} ( \frac{v}{c} {f}_{1} + Δ {f}_{c} ) )} \qquad [ Equation 1 ]$$

In Equation 1, k denotes an index (i.e., a value among a set of values) of a subcarrier, K denotes the total number of subcarriers, H₍ₘ_{₁}_{+δ),1}[k] denotes a value when the subcarrier index is k among the second channel estimate values obtained by performing channel estimation on a symbol having a symbol index m₁+δ in a first band, Hₘ_{₁}_{,1}*[k] denotes a value when the subcarrier index is k among the first channel estimate values obtained by performing channel estimation on a symbol having a symbol index m₁ in the first band, m₁ denotes the symbol index of the first symbol, δ denotes a reference symbol interval, A denotes a gain value, Tₛ denotes a symbol duration, v denotes the relative speed between the transmitting device and the receiving device 300, c denotes a speed of an electromagnetic wave, f₁ denotes the first frequency, which is the center frequency of the first band, and Δf_{c} denotes the oscillator frequency offset.

Next, the calculation circuit 620 may calculate a second correlation value, which is a correlation value between the third channel estimate value and the fourth channel estimate value. Here, the calculation circuit 620 may calculate the second correlation value using Equation 2 below.

$${\sum }_{k = 1}^{K} {H}_{( {m}_{2} + δ ) , 2} [ k ] {H}_{{m}_{2} , 2}^{*} [ k ] = {Ae}^{j ( 2 πδ {T}_{s} ( \frac{v}{c} {f}_{2} + Δ {f}_{c} ) )} \qquad [ Equation 2 ]$$

In Equation 2 above, H₍ₘ_{₂}_{+δ),2}[k] denotes a value when the subcarrier index is k among the fourth channel estimate values obtained by performing channel estimation on a symbol having a symbol index m₂+δ in the second band, Hₘ_{₂}_{,2}*[k] denotes a value when the subcarrier index is k among the third channel estimate values obtained by performing channel estimation on a symbol having a symbol index m₂ in the second band, m₂ denotes the symbol index of the third symbol, and f₂ denotes the second frequency, which is the center frequency of the second band.

Here, Equation 1 may be expressed as Equation 3 below, and Equation 2 may be expressed as Equation 4 below.

$$∠ {\sum }_{k = 1}^{K} {H}_{( {m}_{1} + δ ) , 1} [ k ] {H}_{{m}_{1} , 1}^{*} [ k ] = 2 πδ {T}_{s} ( \frac{v}{c} {f}_{1} + Δ {f}_{c} ) \qquad [ Equation 3 ]$$

$$∠ {\sum }_{k = 1}^{K} {H}_{( {m}_{2} + δ ) , 2} [ k ] {H}_{{m}_{2} , 2}^{*} [ k ] = 2 πδ {T}_{s} ( \frac{v}{c} {f}_{2} + Δ {f}_{c} ) \qquad [ Equation 4 ]$$

Finally, the calculation circuit 620 may calculate the relative speed v based on the first correlation value and the second correlation value. Here, the calculation circuit 620 may calculate the relative speed v using Equation 5 below, which is a result of subtracting Equation 4 from Equation 3.

$$∠ {\sum }_{k = 1}^{K} {H}_{( {m}_{1} + δ ) , 1} [ k ] {H}_{{m}_{1} , 1}^{*} [ k ] - ∠ {\sum }_{k = 1}^{K} {H}_{( {m}_{2} + δ ) , 2} [ k ] {H}_{{m}_{2} , 2}^{*} [ k ] = 2 πδ {T}_{s} ( \frac{v}{c} ( {f}_{1} - {f}_{2} ) ) \qquad [ Equation 5 ]$$

The calculation circuit 620 may calculate the value of the left side of Equation 5 (left of the =sign) based on the channel estimate values received from the channel estimation circuit 610 and may calculate the relative speed v using the known values for the reference symbol interval, the symbol duration, the speed of the electromagnetic wave, the first frequency and the second frequency. (The calculation circuit 620 may finally calculate the relative speed v by dividing the left side of Equation 5 by ((2πδTₛ) (f₁-f₂)) and multiplying the result by c.)

After calculating the relative speed v, the calculation circuit 620 may calculate the Doppler shift frequency based on the relative speed v. Here, the calculation circuit 620 may calculate the Doppler shift frequency using Equation 6 below.

$${f}_{d} = \frac{v}{c} {f}_{1} \qquad [ Equation 6 ]$$

In Equation 6 above, fa denotes the Doppler shift frequency. In this manner, the calculation circuit 620 may calculate the Doppler shift frequency based on the relative speed, the first frequency, and the speed of the electromagnetic wave.

In addition, after calculating the relative speed, calculation circuit 620 may calculate the oscillator frequency offset based on the relative speed. Here, the calculation circuit 620 may calculate the oscillator frequency offset using Equation 3 or Equation 4.

In the case of using Equation 3, the calculation circuit 620 may calculate the oscillator frequency offset based on the first channel estimate value, the second channel estimate value, the relative speed, the first frequency, the speed of the electromagnetic wave, the reference symbol interval, and the symbol duration. In the case of using Equation 4, the calculation circuit 620 may calculate the oscillator frequency offset based on the third channel estimate value, the fourth channel estimate value, the relative speed, the first frequency, the speed of the electromagnetic wave, the reference symbol interval, and the symbol duration.

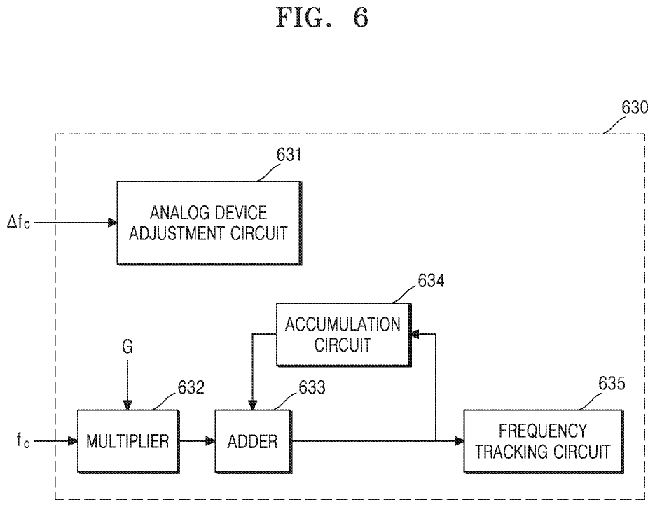

The compensation circuit 630 may adjust a value of an analog device of the oscillator 500 so that the oscillator frequency offset is reduced or eliminated based on the oscillator frequency offset, and track the frequency of the oscillator 500 so that the Doppler shift frequency is compensated for. A detailed structure and operation of the compensation circuit 630 are described below with reference to FIG. 6.

As described above, because the receiving device 300 according to the inventive concept calculates the Doppler shift frequency and the oscillator frequency offset based on the first reference signal and the second reference signal, adjusts the value of the analog device included in the oscillator through the compensation circuit 630, and tracks the frequency of the oscillator, degradation in communication performance between the transmitting device and the receiving device may be prevented.

In an embodiment, the receiving device 300 may further include a global navigation satellite system (GNSS) circuit 700 (see FIG. 2). The GNSS circuit 700 allows the transceiver 400 of the receiving device 300 to receive a GNSS signal from an external satellite.

The GNSS circuit 700 may obtain an oscillator frequency offset based on the GNSS signal. Also, the GNSS circuit 700 may provide the obtained oscillator frequency offset to the communication processor 600.

The calculation circuit 620 of the communication processor 600 may calculate the Doppler shift frequency based on the oscillator frequency offset received from the GNSS circuit 700 and the first and second channel estimate values obtained by performing channel estimation based on the down-converted first reference signal.

In detail, the calculation circuit 620 may calculate the relative speed between the transmitting device and the receiving device 300 based on the oscillator frequency offset received from the GNSS circuit 700 and the first and second channel estimate values. The calculation circuit 620 may calculate the relative speed using Equation 3 above (by isolating the variable v using further arithmetic as described above). The calculation circuit 620 may calculate the value of the left side of Equation 3 using the channel estimate values received from the channel estimation circuit 610 and may calculate the relative speed through knowledge of the reference symbol interval, the symbol duration, the speed of the electromagnetic wave, the first frequency, and the oscillator frequency offset.

Also, the calculation circuit 620 may calculate the Doppler shift frequency based on the relative speed. Here, the calculation circuit 620 may calculate the Doppler shift frequency using Equation 6 above.

In this manner, when the receiving device 300 includes the GNSS circuit 700, the calculation circuit 620 may calculate the Doppler shift frequency and the oscillator frequency offset based on the first to fourth channel estimate values or calculate the Doppler shift frequency based on the oscillator frequency offset and the first and second channel estimate values received from the GNSS circuit 700.

FIG. 6 is a circuit diagram illustrating a detailed structure of the compensation circuit 630 of the receiving device 300 according to an embodiment.

Referring to FIG. 6, the compensation circuit 630 may receive the oscillator frequency offset Δf_{c} and the Doppler shift frequency fa.

The compensation circuit 630 may include an analog device adjustment circuit 631, a multiplier 632, an adder 633, an accumulation circuit 634, and a frequency tracking circuit 635.

The analog device adjustment circuit 631 may adjust the value of an analog device (not shown) of the oscillator 500 so that the oscillator frequency offset decreases based on the received oscillator frequency offset Δf_{c}. Here, the analog device adjustment circuit 631 may adjust the value of the analog device included in the oscillator 500 so that an error in a frequency curve according to temperature (and/or at least one other environmental condition such as humidity) is adjusted. For example, the analog device adjustment circuit 631 may adjust the value of the analog device included in the oscillator 500 such that a frequency of a clock signal generated by the oscillator 500 cancels out or nearly cancels out the oscillator frequency offset. (When canceled out, the oscillator frequency offset may be reduced to zero, i.e., eliminated).

The multiplier 632 may receive the Doppler shift frequency fa and a gain value G. The gain value G may denote the extent to which the frequency tracking circuit 635 tracks the Doppler shift frequency f_{d}. In one example, the gain value G may be pre-set to 0.1.

The multiplier 632 may output a value obtained by multiplying the Doppler shift frequency f_{d} by the gain value G to the adder 633.

The adder 633 may add an output value from the multiplier 632 to an output from the accumulation circuit 634. A calculated value of the adder 633 may be output to the accumulation circuit 634 and the frequency tracking circuit 635.

The accumulation circuit 634 may store the output value of the adder 633. Also, the accumulation circuit 634 may transfer the stored value to the adder 633. Accordingly, the adder 633 may continuously add the value obtained by multiplying the Doppler shift frequency f_{d} by the gain value G, and the value may be stored in the accumulation circuit 634.

The frequency tracking circuit 635 may track the frequency of the oscillator 500 so that the Doppler shift frequency is compensated for based on an output value from the adder 633. In other words, the oscillator 500 frequency is adjusted based on the calculated Doppler shift frequency.

By adjusting the value of the analog device included in the oscillator and tracking the frequency of the oscillator via the compensation circuit 630 according to the inventive concept, a deterioration in communication performance between the transmitting device and the receiving device may be prevented.

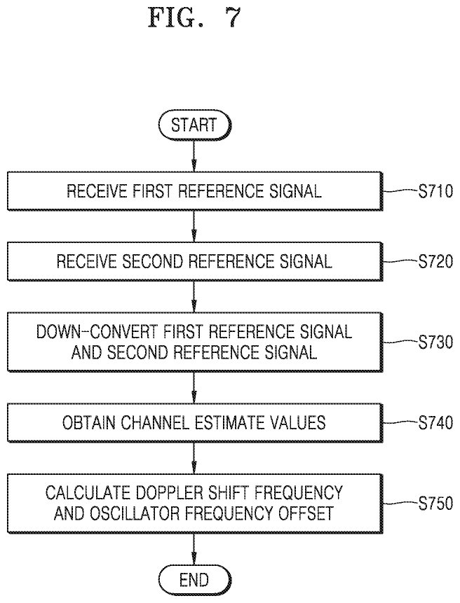

FIG. 7 is a flowchart illustrating an operating method of the receiving device 300 according to an embodiment.

Referring to FIG. 7, in operation S710, the receiving device 300 may receive the first reference signal through the transceiver 400. Here, the first reference signal may be a signal included in a band in which the center frequency is the first frequency.

In operation S720, the receiving device 300 may receive the second reference signal through the transceiver 400. Here, the second reference signal may be a signal included in a band in which the center frequency is the second frequency.

In operation S730, the receiving device 300 may down-convert the first reference signal and the second reference signal through the transceiver 400. The transceiver 400 may down-convert each of the first and second reference signals to be included in an oscillator band group in which the center frequency is the oscillator frequency.

In operation S740, the communication processor 600 of the receiving device 300 may obtain a plurality of channel estimate values. The communication processor 600 may obtain the first channel estimate value and the second channel estimate value based on the first symbol and the second symbol of the first reference signal. In addition, the communication processor 600 may obtain the third channel estimate value and the fourth channel estimate value based on the third symbol and fourth symbol of the second reference signal.

Here, the symbol interval between the first and second symbols of the first reference signal may be the same as the symbol interval between the third and fourth symbols of the second reference signal.

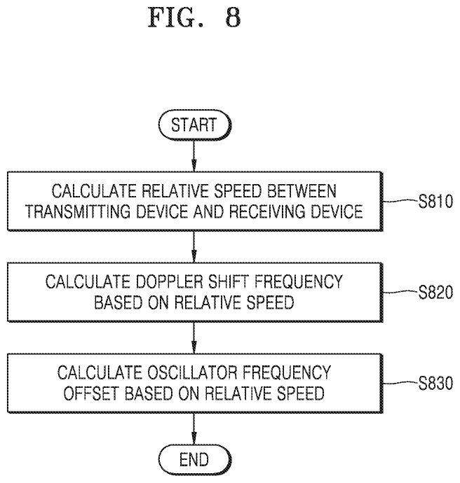

In operation S750, the communication processor 600 of the receiving device 300 may calculate the Doppler shift frequency and the oscillator frequency offset. Further, the communication processor 600 may calculate a relative speed between the transmitting device and the receiving device 300 based on the channel estimate values calculated in operation S740 and calculate the Doppler shift frequency and the oscillator frequency offset based on the relative speed. An example of operation S750 is described in detail through FIG. 8.

FIG. 8 is a flowchart illustrating a method by which the receiving device 300 calculates a Doppler shift frequency and an oscillator frequency offset according to an embodiment.

Referring to FIG. 8, in operation S810, the communication processor 600 of the receiving device 300 may calculate a relative speed between the transmitting device and the receiving device 300, e.g., using Equation 5 above. To this end, the communication processor 600 may calculate the relative speed based on the channel estimate values, the reference symbol interval, the symbol duration, the speed of the electromagnetic wave, the first frequency, and the second frequency.

In operation S820, the communication processor 600 may calculate the Doppler shift frequency based in part on the relative speed, e.g., using Equation 6 above. For example, the communication processor 600 may calculate the Doppler shift frequency based on the relative speed, the first frequency, and the speed of the electromagnetic wave.

In operation S830, the communication processor 600 may calculate the oscillator frequency offset based in part on the relative speed, e.g., using Equation 3 or Equation 4 above. For example, the communication processor 600 may calculate the oscillator frequency offset based on the first channel estimate value, the second channel estimate value, the relative speed, the first frequency, the speed of the electromagnetic wave, the reference symbol interval, and the symbol duration or may calculate the oscillator frequency offset based on the third channel estimate value, the fourth channel estimate value, the relative speed, the first frequency, the speed of the electromagnetic wave, the reference symbol interval, and the symbol duration.

As described above, the receiving device 300 according to an embodiment of the inventive concept may calculate the Doppler shift frequency and the oscillator frequency offset based on the first reference signal and the second reference signal, thereby preventing deterioration in communication performance between the transmitting device and the receiving device.

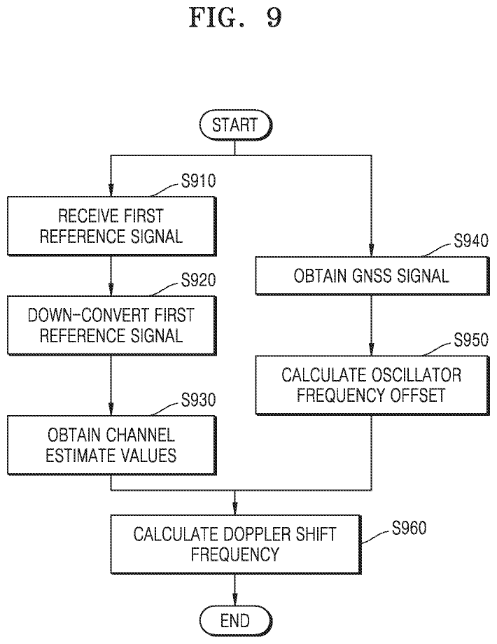

FIG. 9 is a flowchart illustrating a method for the receiving device 300 to calculate an oscillator frequency offset and a Doppler shift using a GNSS circuit according to an embodiment.

Referring to FIG. 9, in operation S910, the receiving device 300 may receive the first reference signal through the transceiver 400. Here, the first reference signal may be a signal included in a band having the first frequency as the center frequency.

In operation S920, the receiving device 300 may down-convert the first reference signal through the transceiver 400. The transceiver 400 may down-convert the first reference signal to be included in an oscillator band group in which the center frequency is the oscillator frequency.

In operation S930, communication processor 600 of the receiving device 300 may obtain a plurality of channel estimate values. The communication processor 600 may obtain a first channel estimate value and a second channel estimate value based on the first symbol and the second symbol of the first reference signal.

In operation S940, the receiving device 300 may receive a GNSS signal via the transceiver 400. Here, the GNSS signal may be a signal received from an external satellite.

In operation S950, the receiving device 300 may obtain an oscillator frequency offset based on the GNSS signal via the GNSS circuit 700.

Here, operations S940 to S950 may be performed in parallel with operations S910 to S930.

In operation S960, the receiving device 300 may calculate the Doppler shift frequency via the communication processor 600. The communication processor 600 may calculate the Doppler shift frequency using Equation 3 and Equation 6 above. To this end, the communication processor 600 may calculate the relative speed based on the channel estimate values, the reference symbol interval, the symbol duration, the speed of the electromagnetic wave, the first frequency, and the oscillator frequency offset and calculate the Doppler shift frequency based on the relative speed, the first frequency, and the speed of the electromagnetic wave.

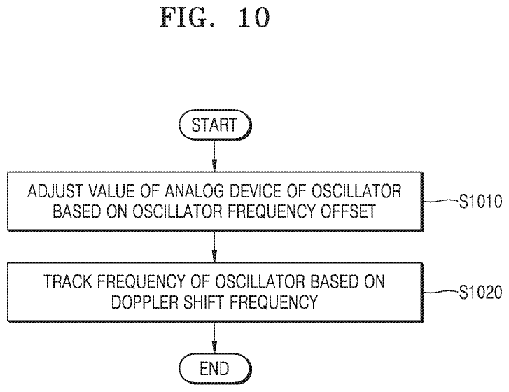

FIG. 10 is a flowchart illustrating a method for the receiving device 300 to perform a compensation operation based on the calculated oscillator frequency offset and Doppler shift according to an embodiment.

Referring to FIG. 10, in operation S1010, the communication processor 600 of the receiving device 300 may adjust the value of the analog device of the oscillator to reduce the oscillator frequency offset based on the oscillator frequency offset. The communication processor 600 may adjust the value of the analog device included in the oscillator 500 based on the oscillator frequency offset so that an error of the frequency curve according to temperature is adjusted. In other examples, the error of the frequency curve according to one or more other environmental condition, e.g., humidity or pressure, is adjusted.

In operation S1020, the receiving device 300 may track the frequency of the oscillator so that the Doppler shift frequency is compensated for based on the Doppler shift frequency, via the communication processor 600. The communication processor 600 may track the frequency of the oscillator by accumulating the value of the Doppler shift frequency by a ratio corresponding to a preset gain value.

In this manner, by adjusting the value of the analog device included in the oscillator and tracking the frequency of the oscillator, degradation in communication performance between the transmitting device and the receiving device may be prevented.

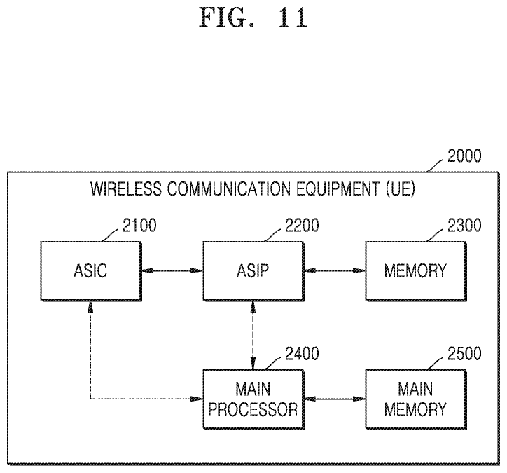

FIG. 11 is a block diagram illustrating a wireless communication device 2000 according to an embodiment.

Referring to FIG. 11, the wireless communication device 2000 may include an application specific integrated circuit (ASIC) 2100, an application specific instruction set processor (ASIP) 2200, a memory 2300, a main processor 2400, and a main memory 2500. Two or more of the ASIC 2100, the ASIP 2200, and the main processor 2400 may communicate with each other. In addition, at least two of the ASIC 2100, the ASIP 2200, the memory 2300, the main processor 2400, and the main memory 2500 may be formed within a single chip.

The ASIC 2100 is an integrated circuit customized for a certain use and may include, for example, a radio-frequency integrated circuit (RFIC), a modulator, a demodulator, etc. The ASIP 2200 may support a dedicated instruction set for a certain application and execute instructions included in the instruction set. The memory 2300 may communicate with the ASIP 2200 and, as a non-transitory storage device, may store a plurality of instructions executed by the ASIP 2200. For example, the memory 2300 may include a certain type memory accessible by the ASIP 2200, such as random access memory (RAM), read-only memory (ROM), tape, magnetic disk, optical disk, volatile memory, non-volatile memory, and combinations thereof.

The main processor 2400 may control the user device 2000 by executing a plurality of instructions. For example, the main processor 2400 may control the ASIC 2100 and ASIP 2200, process data received through a wireless communication network, or process user input to the user device 2000. The main memory 2500 may communicate with the main processor 2400 and, as a non-transitory storage device, may store a plurality of instructions executed by the main processor 2400. For example, the main memory 2500 may be a certain type of memory accessible by the main processor 2400, such as RAM, ROM, tape, magnetic disk, optical disk, volatile memory, non-volatile memory, and combinations thereof.

The components of the receiving device 300 or the operations constituting the operating method of the receiving device 300 according to the embodiments described above may be included in at least one of the components included in the wireless communication device 2000 of FIG. 11. For example, the receiving device 300 of FIG. 2 or at least one of the operations of the operating method of the receiving device 300 may be implemented as a plurality of instructions stored in the memory 2300, and the operation of the receiving device 300 or at least one operation of the receiving device 300 may be performed as the ASIP 2200 executes the instructions stored in the memory 2300. As another example, the receiving device 300 of FIG. 2 or at least one of the operations of the operating method of the receiving device 300 may be implemented as a hardware block to be included in the ASIC 2100. As another example, the receiving device 300 of FIG. 2 or at least one of the operations of the operating method of the receiving device 300 may be implemented as the instructions stored in the main memory 2500, and the receiving device 300 or at least one of the operations of the operating method of the receiving device 300 described above may be performed as the main processor 4400 executes the instructions stored in the main memory 2500.

While the inventive concept has been particularly shown and described with reference to embodiments thereof, it will be understood that various changes in form and details may be made therein without departing from the spirit and scope of the following claims.

What is claimed is:

1. A receiving device comprising:
a transceiver configured to receive, from a transmitting device, a first reference signal included in a band in which a center frequency is a first frequency, receive, from the transmitting device, a second reference signal included in a band in which a center frequency is a second frequency different from the first frequency, and down-convert each of the first reference signal and the second reference signal; and
a communication processor configured to perform channel estimation, based on each of the down-converted first reference signal and the down-converted second reference signal to obtain a plurality of channel estimate values, calculate a Doppler shift frequency and an oscillator frequency offset, based on the plurality of channel estimate values, and perform a compensation operation to compensate for the Doppler shift frequency and reduce or eliminate the oscillator frequency offset.

2. The receiving device of claim 1, wherein
the plurality of channel estimate values include first to fourth channel estimate values, and
the communication processor obtains the first channel estimate value by performing channel estimation based on a first symbol of the first reference signal, obtains the second channel estimate value by performing channel estimation based on a second symbol of the first reference signal, obtains the third channel estimate value by performing channel estimation based on a third symbol of the second reference signal, and obtains the fourth channel estimate value by performing channel estimation based on a fourth symbol of the second reference signal.

3. The receiving device of claim 2, wherein
the first symbol of the first reference signal and the second symbol of the first reference signal are separated by a pre-set reference symbol interval, and
the third symbol of the second reference signal and the fourth symbol of the second reference signal are separated by the pre-set reference symbol interval.

4. The receiving device of claim 2, wherein the communication processor calculates a relative speed between the transmitting device and the receiving device, based on the plurality of channel estimate values and calculates the Doppler shift frequency and the oscillator frequency offset, based on the relative speed.

5. The receiving device of claim 4, wherein the communication processor calculates a first correlation value, which is a value of correlation between the first channel estimate value and the second channel estimate value, calculates a second correlation value, which is a value of correlation between the third channel estimate value and the fourth channel estimate value, and calculates the relative speed based on the first correlation value and the second correlation value.

6. The receiving device of claim 4, wherein the communication processor calculates the Doppler shift frequency based on the relative speed, the first frequency, and a speed of an electromagnetic wave.

7. The receiving device of claim 4, wherein the communication processor calculates the oscillator frequency offset based on the first channel estimate value, the second channel estimate value, the relative speed, the first frequency, a speed of an electromagnetic wave, a reference symbol interval, and a symbol duration.

8. The receiving device of claim 2, wherein
the transceiver receives a global navigation satellite system (GNSS) signal from a satellite,
the receiving device further includes a GNSS circuit configured to obtain the oscillator frequency offset based on the GNSS signal, and
the communication processor calculates the Doppler shift frequency, based on the oscillator frequency offset obtained through the GNSS circuit and the first and second channel estimate values obtained by performing channel estimation based on the down-converted first and second reference signals.

9. The receiving device of claim 8, wherein the communication processor calculates a relative speed between the transmitting device and the receiving device based on the oscillator frequency offset obtained through the GNSS circuit and the first and second channel estimate values, and calculates the Doppler shift frequency based on the relative speed.

10. The receiving device of claim 1, wherein the communication processor adjusts a value of an analog device of an oscillator included in the communication processor based on the calculated oscillator frequency offset so that the oscillator frequency offset decreases, and tracks a frequency of the oscillator so that the Doppler shift frequency is compensated for.

11. An operating method of a receiving device including a transceiver and a communications processor, the operating method comprising:
receiving, from a transmitting device through the transceiver, a first reference signal included in a band in which a center frequency is a first frequency;
receiving, from the transmitting device through the transceiver, a second reference signal included in a band in which a center frequency is a second frequency different from the first frequency;
down-converting, using the transceiver, each of the first reference signal and the second reference signal;
using the communication processor:
performing channel estimation based on each of the down-converted first reference signal and the down-converted second reference signal to obtain a plurality of channel estimate values;
calculating a Doppler shift frequency and an oscillator frequency offset, based on the plurality of channel estimate values; and
performing a compensation operation to compensate for the Doppler shift frequency and reduce or eliminate the oscillator frequency offset.

12. The operating method of claim 11, wherein
the plurality of channel estimate values include first to fourth channel estimate values, and
the obtaining of the plurality of channel estimate values includes:
performing channel estimation based on a first symbol of the first reference signal to obtain the first channel estimate value;
performing channel estimation based on a second symbol of the first reference signal to obtain the second channel estimate value;
performing channel estimation based on a third symbol of the second reference signal to obtain the third channel estimate value; and
performing channel estimation based on a fourth symbol of the second reference signal to obtain the fourth channel estimate value.

13. The operating method of claim 12, wherein
the calculating of the Doppler shift frequency and the oscillator frequency offset includes:
calculating a relative speed between the transmitting device and the receiving device, based on the plurality of channel estimate values;
calculating the Doppler shift frequency, based on the relative speed; and
calculating the oscillator frequency offset, based on the relative speed.

14. The operating method of claim 13, wherein
the calculating of the relative speed includes:
calculating a first correlation value, which is a value of correlation between the first channel estimate value and the second channel estimate value;
calculating a second correlation value, which is a value of correlation between the third channel estimate value and the fourth channel estimate value; and
calculating the relative speed based on the first correlation value and the second correlation value.

15. The operating method of claim 13, wherein the calculating of the Doppler shift frequency includes calculating the Doppler shift frequency based on the relative speed, the first frequency, and a speed of an electromagnetic wave.

16. The operating method of claim 13, wherein the calculating of the oscillator frequency offset includes calculating the oscillator frequency offset based on the first channel estimate value, the second channel estimate value, the relative speed, the first frequency, a speed of an electromagnetic wave, a reference symbol interval, and a symbol duration.

17. The operating method of claim 12, wherein
the receiving device further includes global navigation satellite system (GNSS) circuit, and
the operating method further comprises:
receiving a GNSS signal through the transceiver;
obtaining the oscillator frequency offset through the GNSS circuit, based on the GNSS signal; and
calculating the Doppler shift frequency through the communication processor, based on the oscillator frequency offset obtained through the GNSS circuit and the first and second channel estimate values obtained by performing channel estimation based on the down-converted first reference signal.

18. The operating method of claim 17, wherein
the calculating of the Doppler shift frequency includes:
calculating a relative speed between the transmitting device and the receiving device, based on the oscillator frequency offset obtained through the GNSS circuit and the first and second channel estimate values; and
calculating the Doppler shift frequency based on the relative speed.

19. The operating method of claim 11, further comprising:
adjusting, through the communication processor, a value of an analog device of an oscillator included in the communication processor, so that the oscillator frequency offset decreases based on the oscillator frequency offset; and
tracking, through the communication processor, a frequency of the oscillator so that the Doppler shift frequency is compensated for based on the Doppler shift frequency.

20. A receiving device comprising:
a transceiver configured to receive, from a transmitting device, a first reference signal included in a band in which a center frequency is a first frequency, receive, from the transmitting device, a second reference signal included in a band in which a center frequency is a second frequency different from the first frequency, receive a global navigation satellite system (GNSS) signal from a satellite, and down-convert each of the first reference signal and the second reference signal;
a communication processor configured to perform channel estimation based on the down-converted first reference signal to obtain first and second channel estimate values, and to perform channel estimation based on the down-converted second reference signal to obtain third and fourth channel estimate values; and
a GNSS circuit configured to obtain an oscillator frequency offset, based on the GNSS signal,
wherein the communication processor calculates the Doppler shift frequency and the oscillator frequency offset, based on the first to fourth channel estimate values, or calculates the Doppler shift frequency based on the oscillator frequency offset obtained through the GNSS circuit and the first and second channel estimate values, and performs a compensation operation to compensate for the Doppler shift frequency and reduce or eliminate the oscillator frequency offset.
